(19) United States
(12) Patent Application Publication
(10) Pub. No.: US 2024/0238893 A1
(43) Pub. Date: Jul. 18, 2024

(54) ULTRASONIC WELDING DEVICE

(71) Applicant: SAMSUNG SDI CO., LTD., Yongin-si (KR)

(72) Inventors: Jungsoo KIM, Yongin-si (KR); Gilchoun YEOM, Yongin-si (KR); Myunghyun PARK, Yongin-si (KR); Youngjin LEE, Yongin-si (KR); Jinwon NAM, Yongin-si (KR)

(21) Appl. No.: 18/488,842

(22) Filed: Oct. 17, 2023

(30) Foreign Application Priority Data
Jan. 16, 2023 (KR) 10-2023-0006356

(51) Int. Cl. B23K 20/26; B23K 20/10; H01M 50/516; H01M 50/522; H01M 50/528

(52) U.S. Cl. CPC B23K 20/26; B23K 20/10; H01M 50/516; H01M 50/522; H01M 50/528

(57) ABSTRACT

An ultrasonic welding device is provided. The ultrasonic welding device includes an anvil configured to support a flexible first member below and overlapping a flexible second member, a horn configured to ultrasonically weld the first member and the second member with ultrasonic vibration and by changing elevation upwardly toward the second member, and a guide jig defining an opening corresponding to a welding portion of the first member and the second member and configured to guide elevation and ultrasonic vibration of the horn, the guide jig being configured to cover an external plane of the welding portion with a plane corresponding portion during ultrasonic welding of the first member and the second member.

### CROSS-REFERENCE TO RELATED APPLICATION

The present application claims priority to and the benefit of Korean Patent Application No. 10-2023-0006356, filed on Jan. 16, 2023, in the Korean Intellectual Property Office, the entire disclosure of which is incorporated herein by reference.

### BACKGROUND

### 1. Field

The present disclosure relates to an ultrasonic device for ultrasonically welding flexible members.

### 2. Description of Related Art

Ultrasonic welding is solid-state welding in which welding is performed at a low temperature in preparation for arc welding or laser welding in a relatively short time frame. Ultrasonic welding is environmentally friendly, and may be used to connect only a specific part. Therefore, ultrasonic welding is widely used in the battery industry, the electronic industry, and their corresponding parts.

However, during ultrasonic welding, a welding material might not be completely delaminated after welding, and some material may be attached to a horn used for welding. Accordingly, loss may occur in terms of balance of welding quality and production volume due to a seizure phenomenon.

To improve the process of welding, a horn design may be improved or optimized according to a structure and thickness of the welding material. However, if welding busbars of a ductile material to each other, the appearance and the structure may become non-uniform because of excessive deformation of the ductile material. Accordingly, cracks may be generated in the flexible material, potentially leading to a product failure.

As an example, a secondary battery module may be formed by connecting cylindrical secondary battery cells in series/parallel. To supplement characteristics of the stiffness and vibration of the electrical connection and the structure of the cells, upper and lower members of the flexible busbar are connected to each other by ultrasonic welding.

A guide jig may be used to designate and hold a position of the upper member from among the upper and lower members, and ultrasonic welding is performed thereto. Accordingly, lifting may be generated around the welding portion, and, as a result, quality defects may occur because of interface cracks and because of thickness imbalance between the upper member and the lower member.

### SUMMARY

The present disclosure provides an ultrasonic welding device for controlling deformation of flexible materials during welding, and increasing rigidity and reliability of a welding portion.

The present disclosure also provides an ultrasonic welding device for welding flexible busbar members made of aluminum, and for reducing or preventing the likelihood of members lifting around a welding portion, and reducing or preventing interface cracks and thickness imbalance between two members, thereby increasing welding quality.

One or more embodiments of the present disclosure provide an ultrasonic welding device including an anvil configured to support a flexible first member below and overlapping a flexible second member, a horn configured to ultrasonically weld the first member and the second member with ultrasonic vibration and by changing elevation upwardly toward the second member, and a guide jig defining an opening corresponding to a welding portion of the first member and the second member and configured to guide elevation and ultrasonic vibration of the horn, the guide jig being configured to cover an external plane of the welding portion with a plane corresponding portion during ultrasonic welding of the first member and the second member.

The plane corresponding portion may be configured to be substantially at a same plane as the external plane of the welding portion.

The guide jig may be configured to hold an external lateral side of the welding portion with a lateral corresponding portion.

The lateral corresponding portion may protrude downwardly from the plane corresponding portion at three sides thereof.

The guide jig may include a guide portion defining the opening, the plane corresponding portion, and an installer connected to one side of the guide portion, and configured to be installed in a base.

The guide portion may define the opening in a center thereof, and may include an external portion outside the opening, wherein a first width of the opening in a width direction is greater than a second width of the external portion in the width direction.

A first length of the opening in a length direction may be greater than a second length of the external portion in the length direction on one side of the opening.

The second length may be greater than the second width.

The first member may include a first busbar including first branches configured to be connected to battery cells of a secondary battery module, and a second busbar including second branches spaced by a gap from the first busbar in a length direction, and connected to other battery cells, wherein the second member is configured to connect the first busbar and the second busbar by ultrasonic welding.

The first busbar may further include a first connector on one side with respect to a width direction, wherein the second busbar is spaced from the first connector by the gap, and further includes a second connector on another side with respect to the width direction, and wherein the second member is configured to be connected to the first connector and the second connector by ultrasonic welding.

The first member and the second member may include aluminum.

The first member and the second member may include an aluminum material, wherein the horn includes tungsten (WC) or a tungsten carbide material having strength and stiffness that are greater than those of the first member and the second member.

The first member and the second member may include an aluminum material, wherein the guide jig includes tungsten (WC) or a tungsten carbide material having strength and stiffness that are greater than those of the first member and the second member.

According to the present disclosure, the guide jig having/defining an opening and a plane corresponding portion is applied to cover the plane external portion of the welding portion welded by the first and second members with the plane corresponding portion, and the elevation and ultrasonic vibration of the anvil are guided through the opening, such that the ultrasonic welding may be performed.

According to the present disclosure, if the first and second members are made of a flexible material, the deformation generated by the ultrasonic welding may be controlled. By this, strength and reliability of the welding portion may be obtained.

According to the present disclosure, the aluminum busbar members are covered by using the guide jig and are ultrasonically welded, thereby reducing or preventing the likelihood of lifting of the members around the welding portion.

Therefore, the interface cracks and the thickness imbalance are reduced or prevented between the two members, and welding quality of the welding portion may be improved.

### BRIEF DESCRIPTION OF THE DRAWINGS

FIG. 1 shows a perspective view of applying flexible busbar members to an ultrasonic welding device according to one or more embodiments to enable welding of the same.

FIG. 2 shows a perspective view of disassembled flexible busbar members, a horn, a guide jig, and an anvil of FIG. 1.

FIG. 3 shows a perspective view of a connector of flexible busbar members applied to FIG. 1 and FIG. 2.

FIG. 4A and FIG. 4B respectively show perspective views of a guide jig seen from top and bottom.

FIG. 5 shows a top plan view in which a guide jig is located on flexible busbar members to be welded.

FIG. 6 shows a cross-sectional view taken along the line VI-VI of FIG. 5.

FIG. 7 shows a cross-sectional view taken along the line VII-VII of FIG. 5.

FIG. 8 shows an image if flexible busbar members are welded by using an ultrasonic welding device according to a comparative example 1.

FIG. 9 shows an image if flexible busbar members are welded by using an ultrasonic welding device according to a comparative example 2.

FIG. 10 shows an image in a plan view if flexible busbar members are welded by using an ultrasonic welding device according to one or more embodiments.

FIG. 11 shows an image in a lateral view if flexible busbar members are welded by using an ultrasonic welding device according to one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The present disclosure covers all modifications, equivalents, and replacements within the idea and technical scope of the present disclosure. Further, each of the features of the various embodiments of the present disclosure may be combined or combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions, such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression, such as “at least one of A and B” and “at least one of A or B” may include A, B, or A and B. As used herein, “or” generally means “and/or,” and the term “and/or” includes any and all combinations of one or more of the associated listed items. For example, the expression, such as “A and/or B” may include A, B, or A and B. Similarly, expressions, such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

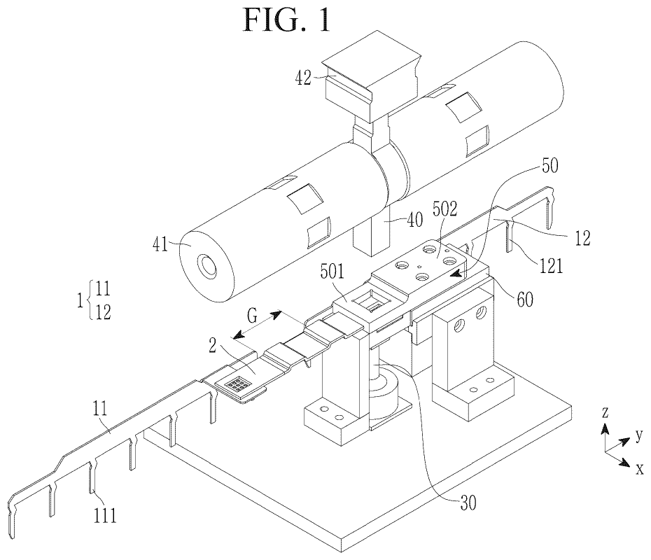

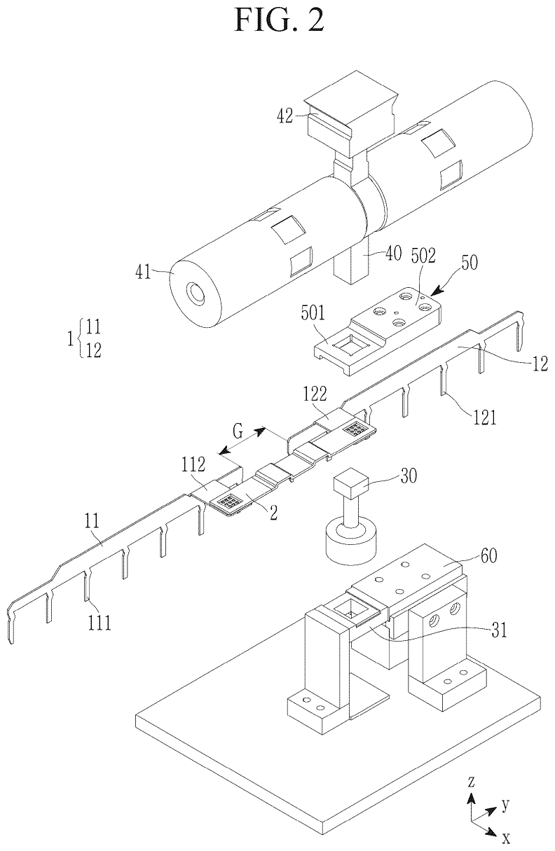

FIG. 1 shows a perspective view of applying flexible busbar members to an ultrasonic welding device according to one or more embodiments to enable welding of the same, and FIG. 2 shows a perspective view of disassembled flexible busbar members, a horn, a guide jig, and an anvil of FIG. 1.

Referring to FIG. 1 and FIG. 2, the ultrasonic welding device may include an anvil 30, a horn 40, and a guide jig 50 to perform ultrasonic welding to a first member 1 and a second member 2 that are flexible, that overlap in a top-down direction (z-axis direction), and that are sequentially located from bottom to top.

For example, the first member 1 may include a first busbar 11 and a second busbar 12. The second member 2 may be connected to the first busbar 11 and the second busbar 12 at respective ends by ultrasonic welding. Therefore, the first busbar 11 may be connected to the second busbar 12 in a length direction (y-axis direction) via the second member 2.

The first busbar 11 may have branches 111 configured to be connected to battery cells provided in a secondary battery module. The second busbar 12 may have branches 121 spaced from the first busbar 11 by a gap G in the length direction (y-axis direction), and configured to be connected to other battery cells.

The battery cells may be formed with a cylindrical secondary battery. The first and second busbars 11 and 12 (e.g., the first member 1 and the second member 2) may connect the battery cells in series/parallel to form a secondary battery module.

Therefore, the first and second members 1 and 2 may be made of a flexible material, and may be connected by ultrasonic welding so as to supplement electrical connection, structural rigidity, and structural vibration. For example, the first and second members 1 and 2 may be made of aluminum.

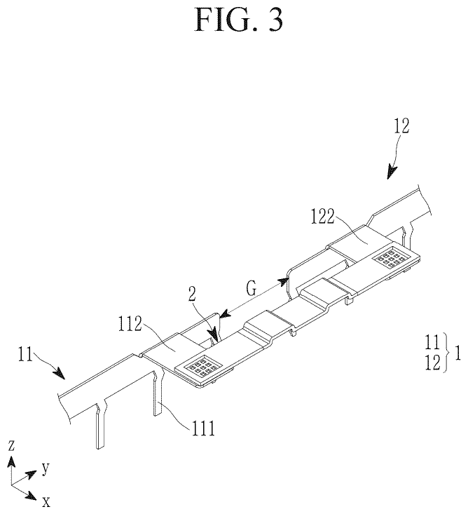

FIG. 3 shows a perspective view of a connector of flexible busbar members applied to FIG. 1 and FIG. 2. Referring to FIG. 1 to FIG. 3, the first busbar 11 may further include a first connector 112 on one side with respect to the width direction (x-axis direction). The second busbar 12 may be spaced from the first connector 112 by the gap G, and may further include a second connector 122 on one side with respect to the width direction (x-axis direction).

The second member 2 may be connected to the first connector 112 and to the second connector 122 at respective ends by ultrasonic welding. Therefore, the first busbar 11 and the second busbar 12 may be connected in the length direction (y-axis direction) by the second member 2, may be located in the secondary battery module, and may be electrically and mechanically connected to the battery cell.

Referring to FIG. 1 and FIG. 2, the anvil 30 may support first and second members 1 and 2 overlapping in the top-to-bottom direction (z-axis direction), and sequentially located from bottom to top, so as to fluently transmit an amplitude of ultrasonic energy to the first and second members 1 and 2 to be welded. The anvil 30 may support the first busbar 11 that is the first member 1 on a lower side, or may support the second busbar 12.

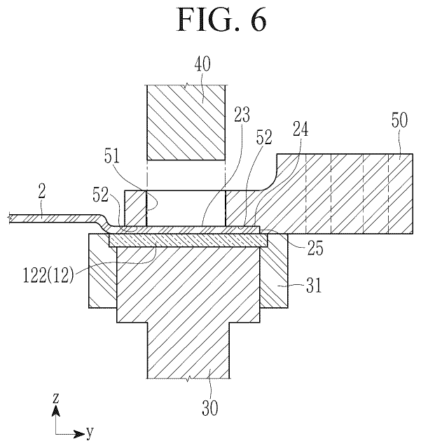

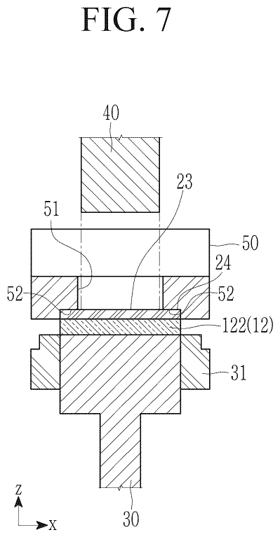

Substantially, the anvil 30 may support the ultrasonic wave amplitude of the horn 40 during ultrasonic welding, may receive a pressure, and may further include an external support portion 31 outside of, or separate from, the anvil 30. The external support portion 31 may support a state in which the first busbar 11, which is the first member 1 on the lower side, or the second busbar 12 is located. The external support portion 31 does not receive the pressure with the ultrasonic wave amplitude (refer to FIG. 6 and FIG. 7).

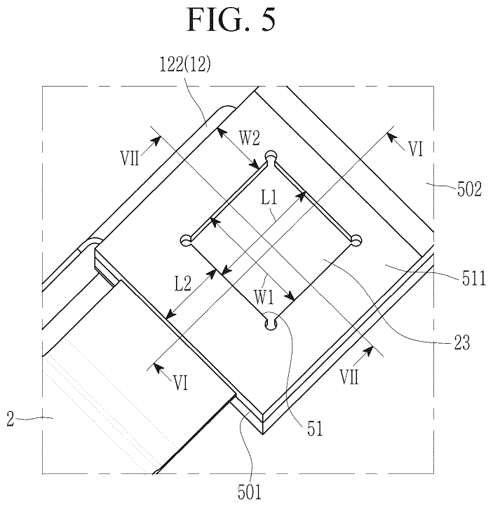

The horn 40 ultrasonically welds the first member 1 and the second member 2 by elevation and ultrasonic vibration at an upper portion of the second member 2. That is, the horn 40 may apply the ultrasonic energy to the first and second members 1 and 2, the ultrasonic energy being provided by the converter 41 and the booster 42 while directly contacting the converter 41 and the booster 42 to be welded, and while being supported by the anvil 30, thereby forming a welding portion 23 (refer to FIG. 5).

For example, the converter 41 may convert electrical energy into mechanical energy to generate the amplitude of ultrasonic energy. The booster 42 may receive the amplitude of ultrasonic energy from the converter 41, may increase or reduce the amplitude (e.g., with a predetermined ratio), and may transmit a resultant amplitude to the horn 40.

The guide jig 50 may be used in the ultrasonic welding of the first and second members 1 and 2, which are made of a flexible material, such as aluminum. The first member 1 may include a first busbar 11 and a second busbar 12 made of aluminum.

The guide jig 50 may control deformation generated during ultrasonic welding of the first and second members 1 and 2, thereby increasing welding strength and welding reliability on the welding portion 23. The guide jig 50 may fix a position of the second member 2 on an upper side, and may surround a peripheral portion of the horn 40 to control lifting and deformation around the welding portion 23.

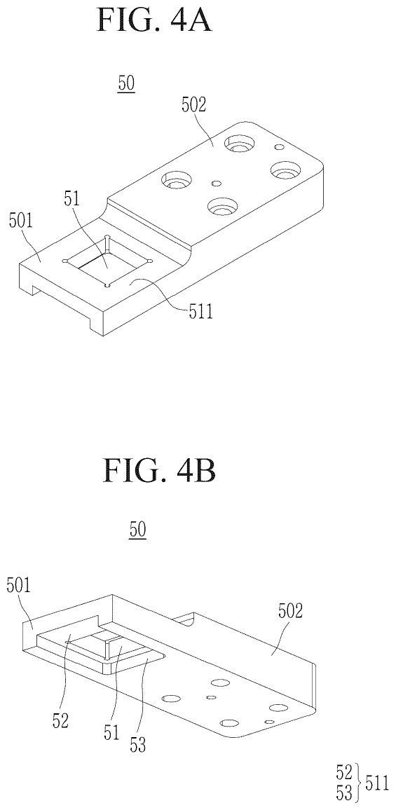

FIG. 4A and FIG. 4B respectively show perspective views of a guide jig seen from top and bottom. Referring to FIG. 1, FIG. 2, FIG. 4A, and FIG. 4B, the guide jig 50 may include/define an opening 51, and may include a plane corresponding portion 52. The guide jig 50 may further include a lateral corresponding portion 53.

FIG. 5 shows a top plan view in which a guide jig is located on flexible busbar members to be welded. Referring to FIG. 4A, FIG. 4B, and FIG. 5, if viewed in the xy plane (e.g., in plan view), the opening 51 forms a substantially quadrangular closed space, enabling the horn 40 to ascend and descend, and enabling the amplitude operation of ultrasonic energy to pass through the opening 51.

The opening 51 is formed to penetrate in an area corresponding to the welding portion 23 of the first and second members 1 and 2 for ultrasonically welding the first and second members 1 and 2, to guide the elevation and ultrasonic vibration of the horn 40, and to provide the opening for the welding portion 23.

FIG. 6 shows a cross-sectional view taken along the line VI-VI of FIG. 5, and FIG. 7 shows a cross-sectional view taken along the line VII-VII of FIG. 5. Referring to FIG. 4A, FIG. 4B, and FIG. 5 to FIG. 7, in one or more embodiments, the plane corresponding portion 52 formed on an external side of the opening 51 may allow formation of the welding portion 23 at a portion that corresponds to the opening 51, and may cover an external plane (e.g., a perimeter of a planar surface) 24 of the welding portion 23 that is an upper side of the second member 2, and may fix the same.

Therefore, if the horn 40 vibrates with ultrasonic energy to form the welding portion 23, the plane corresponding portion 52 may control deformation of the external plane around the welding portion 23. For this purpose, the plane corresponding portion 52 may be formed as the same plane in four directions from among respective sides corresponding to the length direction (y-axis direction) and respective sides corresponding to the width direction (x-axis direction) of the first member 1 and the second member 2 on the external plane 24 of the welding portion 23.

The guide jig 50 may further hold an external lateral side 25 of the welding portion 23 with the lateral corresponding portion 53. The lateral corresponding portion 53 may protrude downwardly from the plane corresponding portion 52 at three sides from among the respective sides of the length direction (y-axis direction) and the respective sides of the width direction (x-axis direction) of the first member 1 and the second member 2 on the external plane 24 of the welding portion 23. The lateral corresponding portion 53 may have a height difference from the plane corresponding portion 52.

The guide jig 50 may include a guide portion 501 and an installer 502. The guide portion 501 may include an opening 51 and a plane corresponding portion 52, and may further include a lateral corresponding portion 53. Referring to FIG. 1 and

FIG. 2, the installer 502 may be connected to one side of the guide portion 501, and may be installed in a base 60 of the ultrasonic welding device.

Referring to FIG. 5, the guide portion 501 has the opening 51 in the center, and includes the external portion 511 outside the opening 51, and a first width W1 of the opening 51 in the width direction (x-axis direction) may be greater than a second width W2 of the external portion 511 in the width direction (x-axis direction).

A first length L1 of the opening 51 in the length direction (y-axis direction) may be greater than a second length L2 of the external portion 511 in the length direction (y-axis direction) on one side with respect to the length direction (y-axis direction). The second length L2 may be greater than the second width W2. The second length L2 of the external portion 511 may reduce or prevent the likelihood of the second member 2 lifting at the respective ends of the welding portion 23 in the length direction (y-axis direction), and for this purpose, the second length L2 may be sufficiently or suitably long.

The second width W2 may reduce or prevent the likelihood of the second member 2 lifting at the respective ends of the welding portion 23 in the width direction (x-axis direction), and for this purpose, it may have a sufficient or suitable length. That is, the second length L2 and the second width W2 of the external portion 511 may suppress deformation around the welding portion 23 on the second member 2 located on the upper side around the welding portion 23 of the first and second members 1 and 2.

The external portion 511 may be formed with the plane corresponding portion 52 around the opening 51, and as shown, the external portion 511 may further include a lateral corresponding portion 53 connected to the plane corresponding portion 52. The external portion 511 further including a lateral corresponding portion 53 may more firmly fix the upper side and the lateral side of the second member 2 around the welding portion 23 so it may further suppress deformation around the welding portion 23.

FIG. 6 and FIG. 7 show that the guide jig 50 contacts the upper side and the lateral side of the second member 2. However, a gap spaced between the guide jig 50 and the second member 2 may be set according to power, pressure, and time of ultrasonic wave applied energy. For example, the gap may be set by reflecting an optimized exterior and an allowable deformation level on the level of about 1 mm.

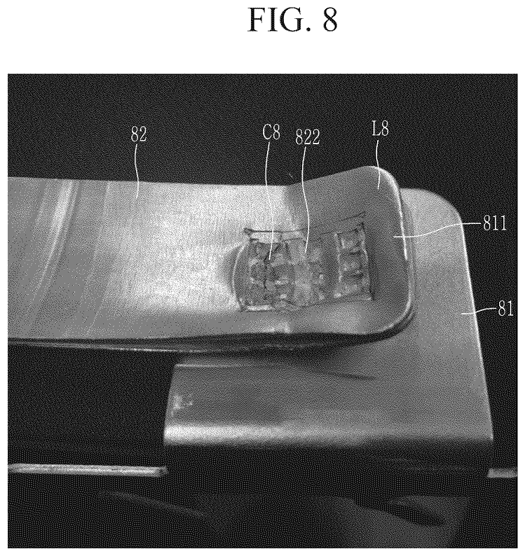

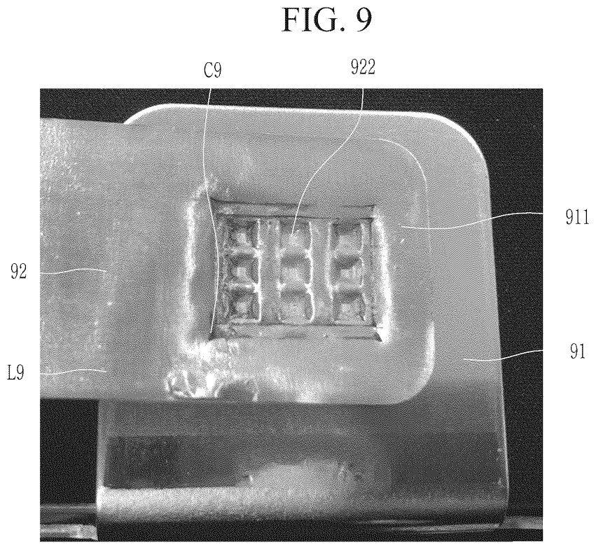

FIG. 8 shows an image if flexible busbar members are welded by using an ultrasonic welding device according to a first comparative example (e.g., comparative example 1), and FIG. 9 shows an image if flexible busbar members are welded by using an ultrasonic welding device according to a second comparative example (e.g., comparative example 2).

Referring to FIG. 5, the guide jig 50 may completely surround the opening 51 with the external portion 511. According to comparative examples 1 and 2, a guide jig may open one side of the opening to hold a member to be welded.

According to the comparative examples 1 and 2, and as shown in FIG. 8 and FIG. 9, as the first members 81 and 91 and the second members 82 and 92 are respectively ultrasonically welded by using the guide jig, the external portions 811 and 911 respectively around the welding portions 822 and 922 may be greatly deformed to respectively generate lifting L8 and L9 and cracks C8 and C9.

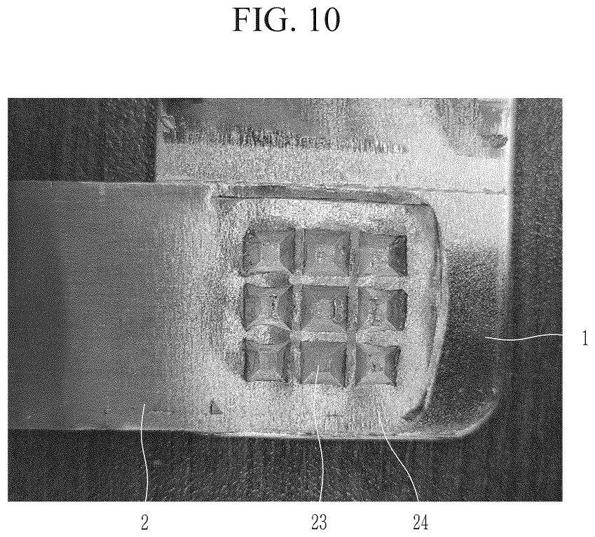

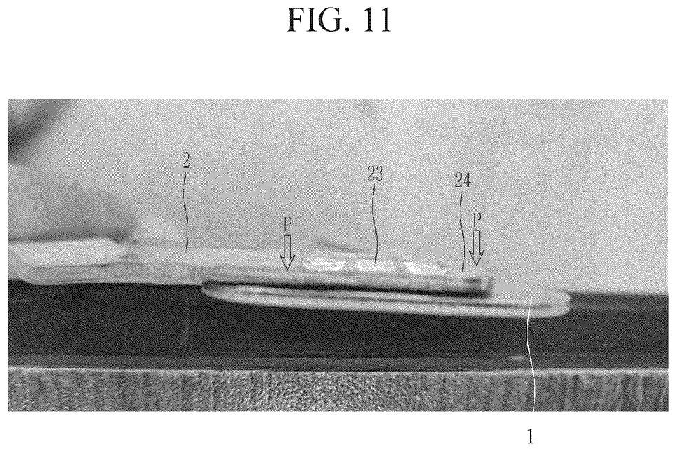

FIG. 10 shows an image in a plan view if flexible busbar members are welded by using an ultrasonic welding device according to one or more embodiments, and FIG. 11 shows an image in a lateral view if flexible busbar members are welded by using an ultrasonic welding device according to one or more embodiments.

Referring to FIG. 10 and FIG. 11, as the first member 1 and the second member 2 are ultrasonically welded by using the guide jig 50 according to one or more embodiments, and as the external plane 24 around the welding portion 23 is pressurized (P) by the external portion 511, and is maintained as fixed, the lifting and cracks described with reference to the comparative examples 1 and 2 are not generated.

In detail, the external plane 24 around the welding portion 23 may be pressurized (P) by the plane corresponding portion 52, and a movement of the external lateral side 25 of the welding portion 23 may be restricted by the lateral corresponding portion 53. Therefore, the lifting and cracks around the welding portion 23 to which the first member 1 and the second member 2 are ultrasonically welded may be further reduced or prevented.

For this purpose, the first and second members 1 and 2 may be made of an aluminum material. For example, the horn 40 may be made of very hard tungsten (WC) or a tungsten carbide material with strength and stiffness that are greater than those of the first and second members 1 and 2. The guide jig 50 may be made of very hard tungsten (WC) or a tungsten carbide material with strength and stiffness that are greater than those of the first and second members 1 and 2.

While the present disclosure has been described in connection with what is presently considered to be practical embodiments, it is to be understood that the present disclosure is not limited to the disclosed embodiments, but, on the contrary, is intended to cover various modifications and equivalent arrangements included within the spirit and scope of the appended claims, with functional equivalents thereof to be included therein.

Description of Some Reference Characters

| | |
|---|---|
| 1: | first member |
| 2: | second member |
| 11: | first busbar |
| 12: | second busbar |
| 23: | welding portion |
| 24: | external plane |
| 25: | external lateral side |
| 30: | anvil |
| 40: | horn |
| 41: | converter |
| 42: | booster |
| 50: | guide jig |
| 51: | opening |
| 52: | plane corresponding |
| 53: | lateral corresponding portion |
| 60: | base |
| 111: | branch |
| 112: | first connector |
| 121: | branch |
| 122: | second connector |
| 501: | guide portion |
| 502: | installer |
| C8, C9: | crack |
| G: | gap |
| L1: | first length |
| L2: | second length |
| L8, L9: | lifting |
| W1: | first width |
| W2: | second width |

What is claimed is:

1. An ultrasonic welding device comprising:
an anvil configured to support a flexible first member below and overlapping a flexible second member;
a horn configured to ultrasonically weld the first member and the second member with ultrasonic vibration and by changing elevation upwardly toward the second member; and
a guide jig defining an opening corresponding to a welding portion of the first member and the second member and configured to guide elevation and ultrasonic vibration of the horn, the guide jig being configured to cover an external plane of the welding portion with a plane corresponding portion during ultrasonic welding of the first member and the second member.

2. The ultrasonic welding device as claimed in claim 1, wherein the plane corresponding portion is configured to be substantially at a same plane as the external plane of the welding portion.

3. The ultrasonic welding device as claimed in claim 1, wherein the guide jig is configured to hold an external lateral side of the welding portion with a lateral corresponding portion.

4. The ultrasonic welding device as claimed in claim 3, wherein the lateral corresponding portion protrudes downwardly from the plane corresponding portion at three sides thereof.

5. The ultrasonic welding device as claimed in claim 1, wherein the guide jig comprises:
a guide portion defining the opening;
the plane corresponding portion; and
an installer connected to one side of the guide portion, and configured to be installed in a base.

6. The ultrasonic welding device as claimed in claim 5, wherein the guide portion defines the opening in a center thereof, and comprises an external portion outside the opening, and
wherein a first width of the opening in a width direction is greater than a second width of the external portion in the width direction.

7. The ultrasonic welding device as claimed in claim 6, wherein a first length of the opening in a length direction is greater than a second length of the external portion in the length direction on one side of the opening.

8. The ultrasonic welding device as claimed in claim 7, wherein the second length is greater than the second width.

9. The ultrasonic welding device as claimed in claim 1, wherein the first member comprises:
a first busbar comprising first branches configured to be connected to battery cells of a secondary battery module; and
a second busbar comprising second branches spaced by a gap from the first busbar in a length direction, and connected to other battery cells, and
wherein the second member is configured to connect the first busbar and the second busbar by ultrasonic welding.

10. The ultrasonic welding device as claimed in claim 9, wherein the first busbar further comprises a first connector on one side with respect to a width direction,
wherein the second busbar is spaced from the first connector by the gap, and further comprises a second connector on another side with respect to the width direction, and
wherein the second member is configured to be connected to the first connector and the second connector by ultrasonic welding.

11. The ultrasonic welding device as claimed in claim 9, wherein the first member and the second member comprise aluminum.

12. The ultrasonic welding device as claimed in claim 1, wherein the first member and the second member comprise an aluminum material, and
wherein the horn comprises tungsten (WC) or a tungsten carbide material having strength and stiffness that are greater than those of the first member and the second member.

13. The ultrasonic welding device as claimed in claim 1, wherein the first member and the second member comprise an aluminum material, and
wherein the guide jig comprises tungsten (WC) or a tungsten carbide material having strength and stiffness that are greater than those of the first member and the second member.
